(19) United States
(12) Patent Application Publication
(10) Pub. No.: US 2011/0087708 A1
(43) Pub. Date: Apr. 14, 2011

(54) BUSINESS OBJECT BASED OPERATIONAL REPORTING AND ANALYSIS

(76) Inventors: JAN TEICHMANN, Neustadt/Weinstrasse (DE); Bare Said, St. Leon (DE); Wolfgang Pfeifer, Kerzenheim (DE); Gerrit Simon Kazmaier, Metzingen (DE)

(21) Appl. No.: 12/577,252

(22) Filed: Oct. 12, 2009

(51) Int. Cl. G06F 7/10; G06F 17/30

(52) U.S. Cl. 707/803; 707/E17.044; 707/E17.108

(57) ABSTRACT

Methods and systems are described that involve holistic and flexible operational reporting that does not require transformation of the underlying model or data harmonization since all business data and business logic of standard business processes are modeled and exposed in a standardized way using domain specific language and the operational reports are modeled with the same meta-model as the business data. A user can simply create a given operational report by selecting needed reporting elements of one or more business objects, run the report, and see the results.

### TECHNICAL FIELD

Embodiments of the invention generally relate to the software arts, and, more specifically, to methods and systems for business object based operational reporting and analysis on business application data.

### BACKGROUND

In the business world, reports are often used to inform a reader about selected topics of interest so that information can be used to provide a general view on the subject in hand, to drive decision making, etc. Reports may also include persuasive elements, such as recommendations, suggestions, or other motivating conclusions that indicate possible future actions the report reader could take. The reports can be in different forms, such as graphs, text, tables, and so on; typically, the reports are disseminated through a corporate Intranet as a set of regularly updated Web pages (or “enterprise portal”). Alternatively, they may be emailed directly to users or simply printed out and distributed. There are different types of business reporting, for example, informational reporting, analytical reporting, operational reporting, and so on. Informational reporting is strategic in nature, looking at summarized data and long-time horizons. Informational reporting serves the management and analytical community. Long-term and strategic decisions come from informational reports.

Operational reporting provides employees of a company with thorough and detailed information. Operational reporting is designed to support the detailed day-to-day activities of a corporation at the transaction level, it provides a view on specific data of an enterprise management system that supports control and decision making. In operational reporting, detail is much more important than summary. Examples of operational reporting include balancing reports, daily account audits and adjustments, daily production records, flight-by-flight traveler logs and transaction logs, and so on. These reports are designed to contain details that are essential to the day-to-day tasks of workers at many levels to make the right decisions. Some business scenarios use data warehousing for reporting. Data warehouses are designed to facilitate reporting and analysis. Usually, informational reporting comes from the data warehouse. However, using a data warehouse for operational reporting may lead to difficulties caused by replication of large amount of data and providing such data in-time. In order to generate a report, predefined content of data is determined and replicated in the data warehouse. The predefined content is usually a small subset of the available data in a transactional system, such as Online Transactional Processing (OLTP). Since the operational reporting is to be used by every employee in a company at all levels of the organization, the determination of adequate predefined reporting content becomes very difficult, as each employee may require different data and may need a different report. Thus, large amounts of data have to be replicated at the data warehouse to support all possible scenarios for operational reporting.

The second challenge of using a data warehouse for operational reporting is the provision of in-time data. The replication of the large amounts of data to the data warehouse may result in data latency.

### SUMMARY OF THE INVENTION

Methods and systems are described that involve business object based operational reporting and analysis on business application data. In one embodiment, the method includes receiving a selection of a business object, wherein the business object includes encapsulated business data defined in a business object meta-model. Further, the method includes receiving a selection of a subset of a plurality of elements of the business object, wherein the plurality of elements describe the business data. A structure from the subset of the plurality of elements of the selected business object is created, wherein the structure defines a report model, and wherein the report model is based on the meta-model of the selected business object. Finally, an operational report is generated based on the report model.

In one embodiment, the system includes a plurality of business objects, wherein at least one of the business objects is modeled by a meta-model that defines business data. Further, the system includes a persistency storage unit that stores the plurality of business objects. In addition, a data retrieval engine in communication with multi-source data stores, including the persistency storage unit, retrieves the business data from the plurality of business objects. An in-memory storage unit is in communication with the data retrieval engine that stores and provides indexed business data for search operations. Finally, the system includes a design tool to create and run a report model based on the business object meta-model.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a diagram of an example of a business object meta-model, according to an embodiment of the invention.

FIG. 2 is a diagram of an example of a portion of a business object based report meta-model, according to an embodiment of the invention.

FIG. 3 is a flow diagram of an embodiment for generating and executing a report using a business object based report meta-model.

FIG. 4 is a diagram of an embodiment that shows the design-time components of the system for operational reporting and analysis.

FIG. 5 is a diagram of an embodiment that shows runtime components of the system for operational reporting and analysis.

FIG. 6 is a block diagram of an exemplary computer system 600, according to an embodiment of the invention.

### DETAILED DESCRIPTION

Embodiments of techniques for business object based operational reporting and analysis are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments

In an embodiment, operational reporting builds reports based on application platform data. The application platform consists of a set of business objects that cover and implement standard business processes including, but not limited to, sales order processing, invoice processing, and so on. In an embodiment, the application platform includes an online transactional processing (OLTP) system that facilitates and manages transaction-oriented applications. The business objects may be modeled and implemented in a standardized way by following a given object meta-model, modeling methodology, and a common implementation framework. A meta-model typically defines the language and processes from which to form a model, while the modeling methodology is the analysis, construction and development of the frames, rules, constraints, models and theories applicable and useful for the modeling itself.

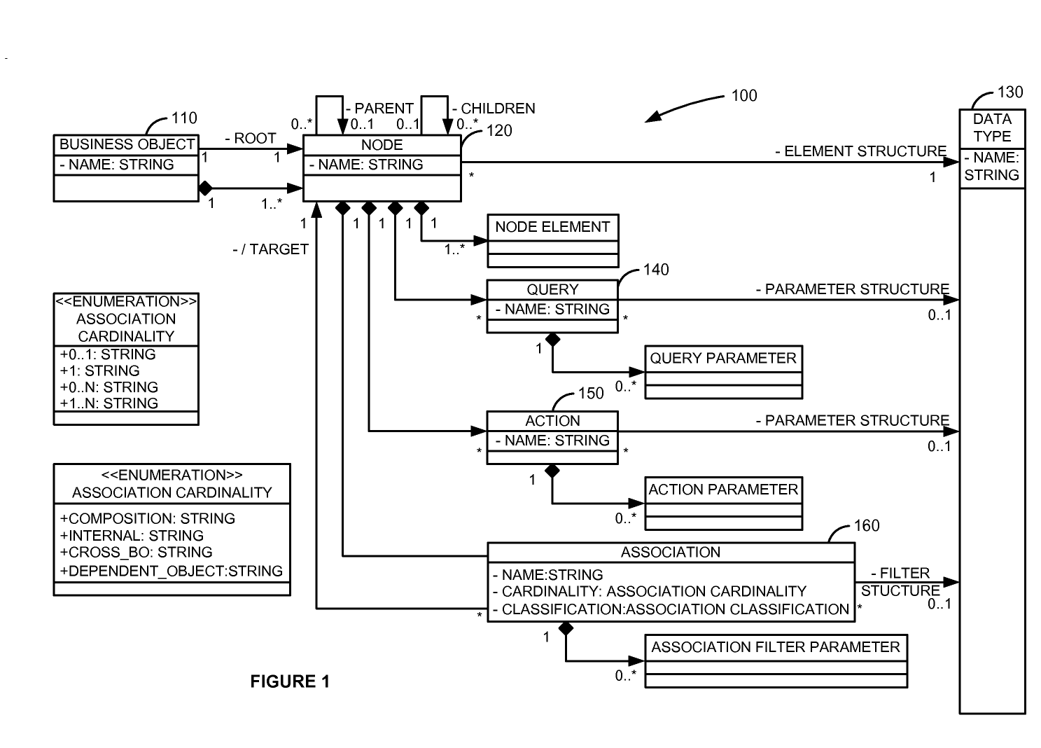

FIG. 1 is a diagram of an example of a business object meta-model, according to an embodiment of the invention. Business data needed for the business processes of the application platform may be encapsulated in business objects that provide standardized and domain-specific access interfaces to all business data. The business objects are objects that represent the entities in a business domain that a program is designed to support. For example, an order entry program might have business objects to represent orders, line items, and invoices the program is processing. A business object is an instance of a business object type. A business object type is the representation of a business entity in an enterprise system. It encompasses both the functionality (in the form of methods) and the data (in the form of attributes) of this entity. The implementation details of the business object type are hidden from the user. The business object type is accessed through defined functions (methods). This is referred to as encapsulation. Business object types may be used to break a system down into smaller, disjunctive units. As a result, the system's structure is improved while its complexity is reduced. At business object type level, various business components can communicate with each other. The business data contained in a business object may be modeled via modeling languages in a business object model. The business object model is an abstraction that presents the relations of a group of entities. Often times, a model conforms to a unique meta-model. For example, a model may conform to its meta-model the same way a computer program conforms to the grammar of the programming language in which it has been written. The meta-model is yet another abstraction that highlights some of the properties (attributes, elements, etc.) of the model itself.

Schema 100 shows an example of a meta-model of a business object 110. To encapsulate data and business processes, the business objects are defined as entities. In one embodiment, business object 110 is a code construct that corresponds directly to entity nodes 120, which the business object 110 represents. A business object may have one root entity node and zero or more child entity nodes below the root node. Therefore, the relation between business object 110 and entity nodes 120 is twofold: 1) 1:1 for the root node; and 2) 1:0 . . . * for all other nodes. The business object 110 encapsulates the business logic related to entity nodes 120 and encapsulates the data that is required by the logic. Entity nodes 120 are defined with data types 130 and one or more entity node elements as part of the business logic that further describe the business object 110, such as query 140, action 150, association 160, and so on. Since the business data is encapsulated in the business objects and the business objects are defined in business object meta-models, then reports on the business data can be generated by using the business object meta-model.

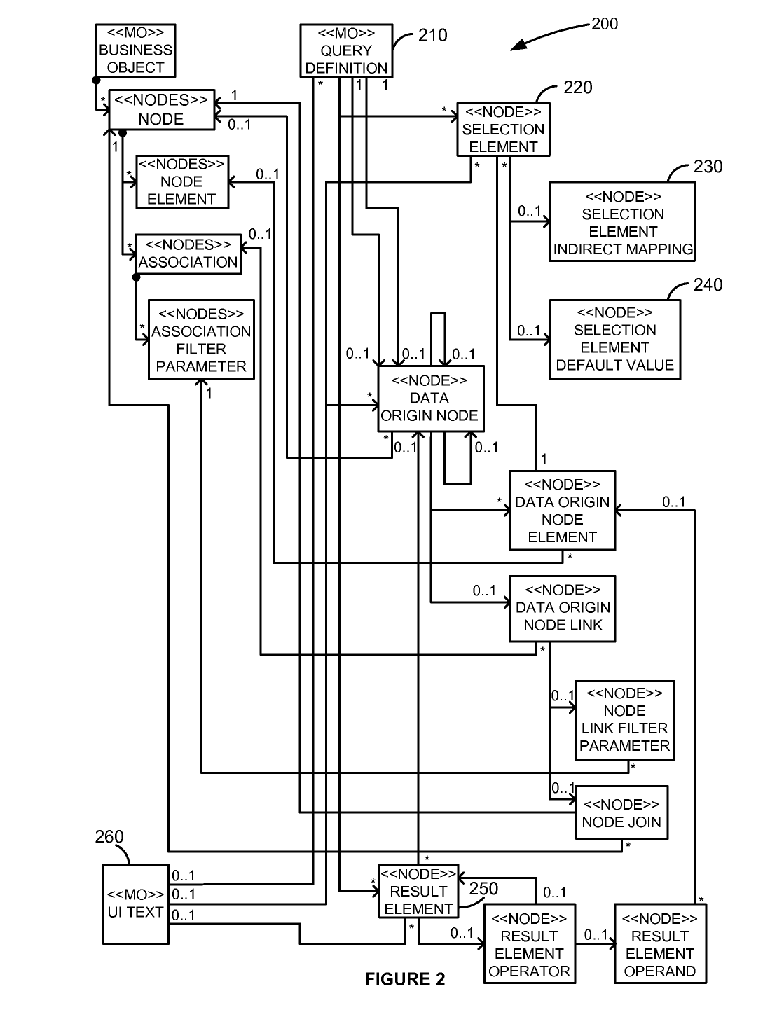

FIG. 2 is a diagram of an example of a portion of a business object based report meta-model, according to an embodiment of the invention. In an embodiment, an operation report may be generated by creating a report meta-model and executing the created report meta-model. Traditional reporting solutions are based on report models that are technically composed of different entities rather than the models of the business data they are intended to report on. This means that the business data and business logic may be modeled via one modeling language and the report modeled via a different modeling language. In this case, the two meta-models (the one of the business data and the one of the reporting) have to be additionally harmonized. This may also require transformation of the underlying business data. In an embodiment, the report meta-model may be based on the same meta-model for defining the business data, using the same domain-specific modeling language. In this way, no additional transformation of the underlying meta-model or data harmonization is needed to design the report meta-model.

Schema 200 shows a portion of a report meta-model based on business object meta-model 100. A user can create a report based on this report meta-model that fulfils his or her needs by choosing one or more business objects and selecting particular attributes of the business objects that represent the relevant business data (e.g., sales order). The report meta-model defines which business data to be exposed from the business object meta-model and which data to be seen in the report. The report meta-model may consist of several structures including, but not limited to, a selection structure, a result structure, and a filter and expression structure. Elements of the selection structure (e.g., nodes 220, 230, and 240) and elements of the result structure (e.g., node 250) may be defined as elements with attributes of the underlying business objects, which contain the relevant reporting business data. In an embodiment, meta object 210 specifies which fields will be shown from the different entity nodes that contain the business data. Meta object 210 has references to selection element nodes 220, 230, and 240 that are involved in the selection of the business data for reporting. Further, report meta-model may include result element nodes, such as result element node 250. The result element node 250 defines a flat structure (e.g., a row) of fields providing specific business data needed for the report. The report meta-model may include meta object 260 that defines a set of user interface (UI) elements for displaying the flat structure. In an embodiment, the set of UI elements are UI texts that can be reused among several report models or even meta-model instances of different type (e.g., report meta-model, business object meta-model, etc. could use the same UI texts). The report designer has the flexibility to decide what business data to be included in the report, generate the report, execute the report, and display the result of the report in a UI screen.

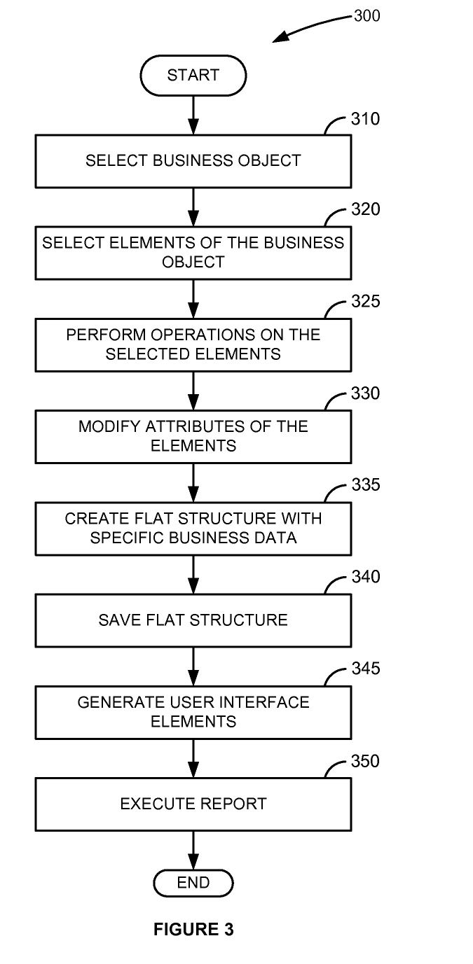

FIG. 3 is a flow diagram of an embodiment for generating and executing a report using a business object based report meta-model. Process 300, generation and execution of the business object based report meta-model, enables ad hoc operational reporting and analysis on business application data. In an embodiment, business data is encapsulated in business objects. The business objects are stored and provided with an application platform. At block 310, one or more business objects are selected depending on what business data is needed for the operational report and analysis. The report designer may select those business objects that he or she needs for the report. At block 320, elements of the selected business object can be selected and modified. The user can select what business data to be included in the report by further specifying elements of the selected business objects. For example, a user can select a Currency Code element of a business object to provide currency code information in the report. At block 325, various operations may be performed on business object elements to provide more specific business data results. These operations may include filtering, aggregation, sorting, obtaining additional data type and UI information, and so on. At block 330, attributes of the selected business object elements can be modified. For example, if the selected business object element is Currency Code, the user can specify display name of the element, description, sorting order, and so on. Thus, the user obtains a set of business object elements representing particular business data needed for the report.

At block 335, a flat structure (e.g., a row of attributes) is created from the set of business object elements providing the specific business data selected from the business objects. The flat structure represents a portion of the meta-model of the report. At block 340, the flat structure is saved. At block 345, a set of user interface (UI) elements (e.g., tab, window, text, field, table, etc.) is created to represent the business data from the flat structure. In an embodiment, the user may select which business object elements to be included in the report. At block 350, the designed report model is executed and the results are displayed in a UI screen. Thus, the user can see the results from the report he or she modeled using the business object based report meta-model.

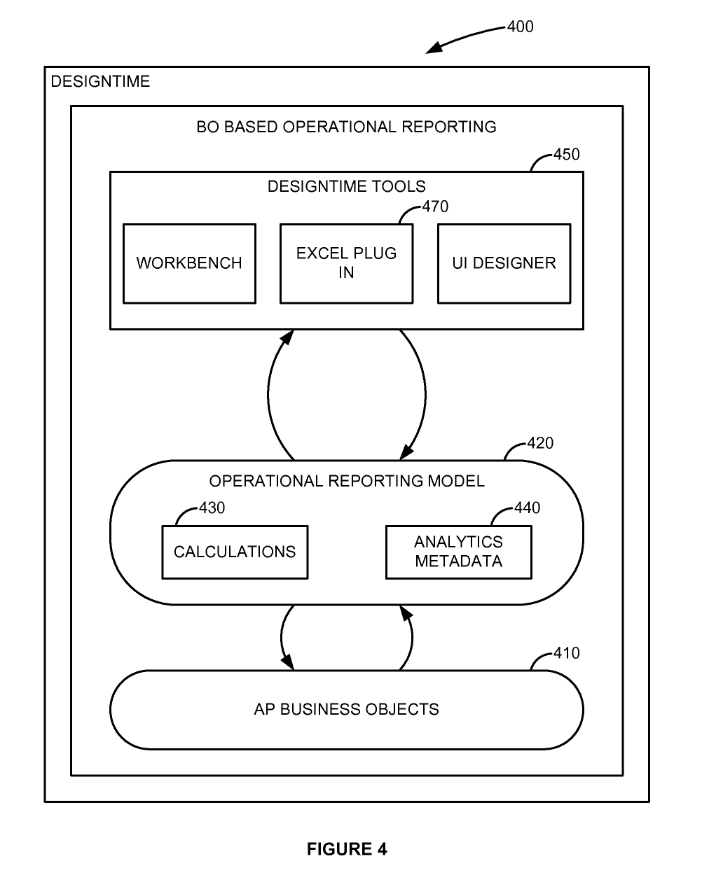

FIG. 4 is a diagram of an embodiment that shows the design-time components of the system for operational reporting and analysis. System 400 represents a diagram of some basic components that can be included in the operational reporting process. The design time is part of the development process of a product, this is the step where the product is being modeled. When referring to a software product, the design time is before the compilation of the source code of a program; while the runtime refers to the time after compilation of the source code while the program is running. System 400 includes the business objects 410 provided with the application platform. The business objects 410 are the basis for the business processes since they represent all business data. Above the application platform business objects 410 is the operational reporting model 420. The operational reporting model is based on the business object meta-model. As described in FIG. 2, the report model (operational reporting model) is based on the underlying business objects meta-model and thus, no transformation of the models is needed to comply with each other or any data harmonization. The operational reporting model 420 may include a set of components for designing the report model. In an embodiment, the report model 420 includes calculations unit 430. The calculations unit 430 may include a set of operations to be performed on the business data of the business objects. These operations may include aggregation and filtering of the business data according to the report model designer's criteria. For example, the report model designer may specify that only purchase orders from a given year, which is to be entered via the UI, to be included in the report.

The operational reporting model 420 may include analytics metadata 440 unit. Via the analytics metadata 440 unit, the report model designer can specify which business object elements to be included in the report model. These elements can be used for business analytics. The operational reporting model 420 may be modeled via design time tools 450. A user can create a report by selecting needed reporting elements from the underlying business objects 410. Using same meta-model for business data model and for reporting model, simplifies the implementation of flexible report design tool. After the report model is designed, the design time tools 250 provide the generated report model to the user via user interfaces. The report model is executed and the results are displayed to the user. In an embodiment, a design time tool can be integrated in a program as a plug-in (e.g., a design time tool 470 as part of the Microsoft® Excel application).

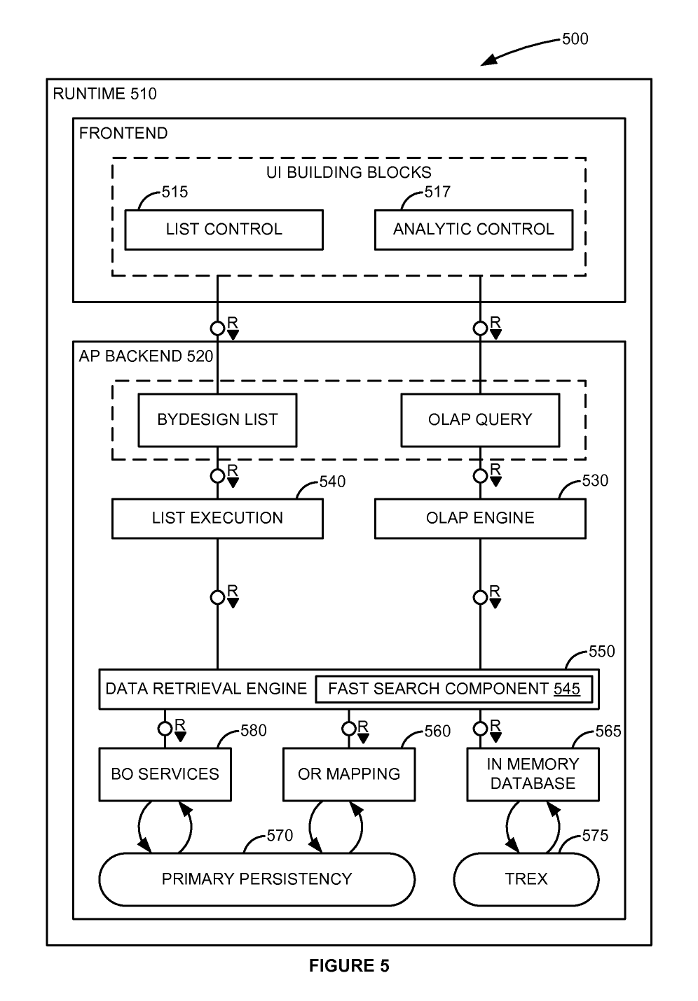

FIG. 5 is a diagram of an embodiment that shows runtime components of the system for operational reporting and analysis. During runtime, a user can run a report model based on a business objects meta-model by selecting specific business data to be exposed from the business objects model. System 500 includes frontend unit 510 and backend unit 520. The frontend unit 510 may be a hardware component, a software component, or a combination of hardware and software components that are closer to the user as part of system 500. For example, a screen displaying user interfaces of a program. The backend unit 520 may be a hardware component, a software component, or a combination of hardware and software components that are farther from the user as part of system 500 (for example, an application server). The user interacts with the backend software components via the frontend components. In an embodiment, the application platform providing the business objects with the encapsulated business data is the backend unit 520. The frontend 510 may provide modeling tools, such as design tools 450, to the user for building meta-models and UI elements. In an embodiment, List control 515 is a UI building block for generating flat reports. Analytic 517 is a UI building block for generating analytical reports. For example, in Microsoft® Excel, a flat report would represent a simple Excel sheet consisting of only columns and rows, while the analytical report would represent a pivot table. A pivot table is a data summarization tool that could automatically sort, count, and total the data stored in one table or spreadsheet and create a second table displaying the summarized data. Both types of reports can be used for operation reporting and analysis.

Via the frontend 510, the user runs an operational report. The operational report may have been created at design-time by system 400. The report request is sent to the backend 520. The request is received at a processing engine, such as online analysis processing (OLAP) query engine 530. The OLAP query engine 530 processes requests for analytics reporting. The flat reports are processed by engine 540. In an embodiment, the processing engines, 530 and 540, may request a multi-source data retrieval engine 550 to obtain the requested business data. The multi-source data retrieval engine 550 is part of the application platform that provides business data encapsulated in business objects in an optimized way. The data retrieval engine 550 may collect the needed data form different sources. In an embodiment, this is done by direct access to database 570 using object-relational (OR) mapping data unit 560. Database 570 is a primary persistency storage unit that stores the business objects. In another embodiment, a fast search engine 545 may forward the request to an in-memory database 565, which contains all business data that has already been indexed. Most of the business objects attributes (except those attributes that have to be calculated) can be indexed and stored in an in-memory database and used as search criteria. The indexing and search engine 575 may return as result all data requested (if this data has been indexed) or just a set of identifiers (IDs) of the business objects containing the requested business data. The IDs can then be used to retrieve the non-indexed data from the primary persistency 570. The IDs allow fast retrieval of data corresponding to the search criteria. Using the indexing and search engine 575 avoids performance problems occurring in operational reporting solutions on top of OLTP systems. Traditional operational reporting solutions may try to optimize the performance by creating additional databank indexes. However, these can influence the performance of the OLTP system in a negative way during data update. Therefore, choosing or creating a databank index in advance means also restricting the scope of the provided reporting solution (since limited predefined reporting content shall be created in advance). Calculated attributes of the business objects may be retrieved using the business object services 580. The business object services 580 provide a set of operations that can be executed on the business objects such as, deleting, creating, updating an object, and so on. All data sources involved in the data retrieval belong to the same transactional system as part of the application platform, no data replication is needed and therefore the retrieved reporting data is always up to the second available and no data latency can occur. Furthermore, the creation and execution of the report meta-model is performed on original business data (no transformation or harmonization of the data occurs) provided with the various data sources, which also leads to no data latency.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable medium as instructions. The term “computer readable medium” should be taken to include a single medium or multiple media that stores one or more sets of instructions. The term “computer readable medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

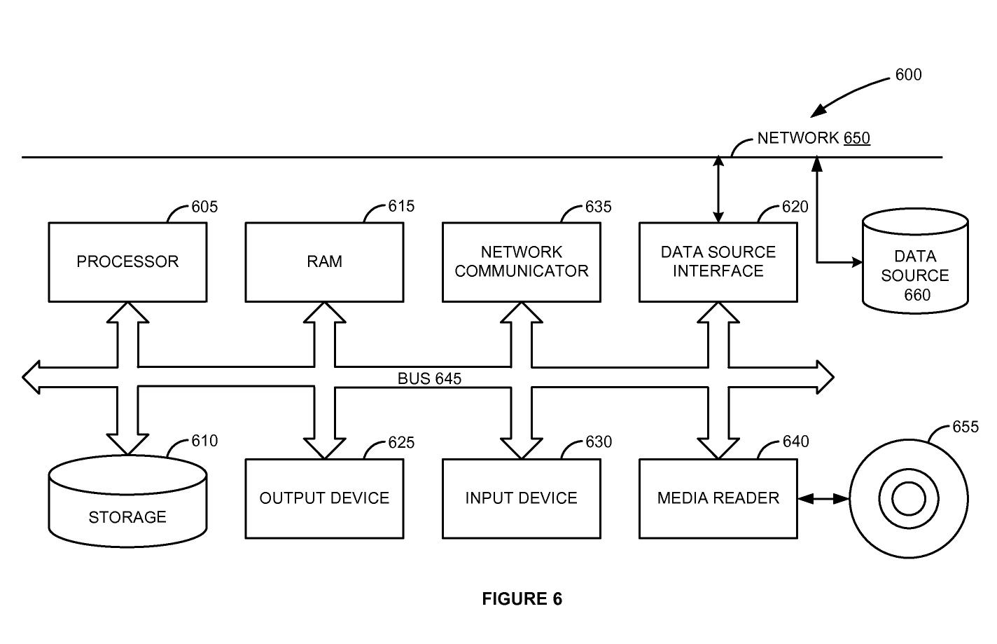

FIG. 6 is a block diagram of an exemplary computer system 600. The computer system 600 includes a processor 605 that executes software instructions or code stored on a computer readable medium 655 to perform the above-illustrated methods of the invention. The computer system 600 includes a media reader 640 to read the instructions from the computer readable medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be access via one or more abstraction layers implemented in hardware or software. For example, the data source 660 may be access by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A machine-readable storage medium tangibly storing machine-readable instructions thereon, which when executed by the machine, cause the machine to perform operations comprising:
detecting a selection of a business object, wherein the business object includes business data defined in a business object meta-model;
detecting a selection of a subset of a plurality of elements of the business object, the plurality of elements describing the business data;
generating a structure at a backend system from the subset of the plurality of elements of the selected business object, wherein the structure defines a report model, and wherein the report model is based on the meta-model of the selected business object; and
generating an operational report at the backend system, wherein the operational report is based on the report model.

2. The machine-readable storage medium of claim 1, wherein the operations further comprise:
generating a set of user interface elements that represent the subset of the plurality of elements of the selected business object.

3. The machine-readable storage medium of claim 2, wherein the structure is a flat structure.

4. The machine-readable storage medium of claim 3, wherein the generated set of user interface elements is based on the flat structure.

5. The machine-readable storage medium of claim 1, wherein the operations further comprise:
modifying attributes of a portion of the subset of the plurality of elements of the selected business object.

6. The machine-readable storage medium of claim 1, wherein the operations further comprise:
executing the operational report with the selected subset of the plurality of elements of the business object; and
displaying results in response to executing the operational report.

7. A computer implemented method comprising:
detecting a selection of a business object, wherein the business object includes encapsulated business data defined in a business object meta-model;
detecting a selection of a subset of a plurality of elements of the business object, the plurality of elements describing the business data;
generating a structure at a backend system from the subset of the plurality of elements of the selected business object, wherein the structure defines a report model, and wherein the report model is based on the meta-model of the selected business object; and
generating an operational report at the backend system, wherein the operational report is based on the report model.

8. The method of claim 7 further comprising:
generating a set of user interface elements that represent the subset of the plurality of elements of the selected business object.

9. The method of claim 8, wherein the structure is a flat structure.

10. The machine-readable storage medium of claim 9, wherein the generated set of user interface elements is based on the flat structure.

11. The method of claim 7 further comprising:
executing a set of operations on a portion of the subset of the plurality of elements of the selected business object, wherein the set of operations includes at least filtering, sorting, and aggregation; and
modifying attributes of the portion of the subset of the plurality of elements of the selected business object.

12. The method of claim 7 further comprising:
executing the operational report with the selected subset of the plurality of elements of the business object; and
displaying results in response to executing the operational report.

13. A computing system comprising:
a plurality of business objects, wherein at least one of the business objects is modeled by a meta-model that defines business data;
a persistency storage unit that stores the plurality of business objects;
a data retrieval engine in communication with multi-source data stores including the persistency storage unit, to retrieve the business data from the plurality of business objects;
an in-memory storage unit in communication with the data retrieval engine that stores and provides indexed business data for search operations; and
a design tool to create and execute an operational report model based on the business object meta-model.

14. The system of claim 13 further comprising:
a processing engine in communication with the data retrieval engine to receive and send query requests to the business data.

15. The system of claim 13 further comprising:
a business services unit in communication with the persistency storage unit that includes a set of services for operating on the business data of the plurality of business objects.

16. The system of claim 13 further comprising:
a fast search component in communication with the in-memory storage unit that triggers the search operations of the indexed business data.

17. The system of claim 13 further comprising:
an indexing and search engine that indexes business object attributes and provides the indexed data to the in-memory storage unit.

18. The system of claim 13, further comprising:
an operational mapping unit that provides the data retrieval engine with access to the persistency storage unit for retrieving business data.

19. The system of claim 13 further comprising:
a set of user interface elements that represent a selected portion of a plurality of elements of a business object; and
a display unit to display the set of user interface elements and to show results in response to executing the operational report model.

20. The system of claim 19, wherein the set of user interface elements is generated based on a flat structure representing the selected portion of a plurality of elements of a business object.
